(19) United States
(12) Patent Application Publication
(10) Pub. No.: US 2008/0266879 A1
(43) Pub. Date: Oct. 30, 2008

(54) OPTICAL PLATE AND BACKLIGHT MODULE USING THE SAME

(75) Inventor: SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/850,041

(22) Filed: Sep. 5, 2007

(30) Foreign Application Priority Data
Apr. 27, 2007 (CN) 200710200527.9

(51) Int. Cl. F21V 13/04; F21V 5/00

(52) U.S. Cl. 362/309; 362/330

(57) ABSTRACT

An exemplary optical plate includes at least one transparent plate unit. The transparent plate unit includes a first surface, a second surface, a plurality of microstructures, a plurality of spherical depressions and a lamp-receiving portion. The second surface is opposite to the first surface. The microstructures are formed at the first surface. Each microstructure includes at least three side surfaces connected with each other, a transverse width of each side surface decreasing along a direction away from the first surface. The spherical depressions are formed at the second surface. The lamp-receiving portion is defined in at least one of the first surface and the second surface. A backlight module using the present optical plate is also provided.

### CROSS-REFERENCE TO RELATED APPLICATIONS

This application is related to eleven copending U.S. patent applications, which are: application Ser. No.11/835,425, Ser. No. 11/835,426, Ser. No. 11/835,427, Ser. No. 11/835,428, Ser. No. 11/835,429, Ser. No. 11/835,430, and Ser. No. 11/835,431, filed on Aug. 8, 2007; application Ser. No. 11/836,799, filed on Aug. 10, 2007; application Ser. No. 11/842,170, filed on Aug. 21, 2007; applicants Ser. No. 11/843,669, and Ser. No. 11/843,670, filed on Aug. 23, 2007, and all entitled “OPTICAL PLATE AND BACKLIGHT MODULE USING THE SAME”; In all these copending applications, the inventor is Shao-Han Chang. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

In a liquid crystal display device, liquid crystal is a substance that does not itself illuminate light. Instead, the liquid crystal relies on light received from a light source, in order that the liquid crystal can facilitate the displaying of information. In the case of a typical liquid crystal display device, a backlight module powered by electricity supplies the needed light.

FIG. 9 represents a typical direct type backlight module 100. The backlight module 100 includes a housing 101, a light reflective plate 102, a light diffusion plate 103, a prism sheet 104, and a plurality of light emitting diode 105 (hereinafter called LED). The housing 101 includes a rectangular base 1011 and four sidewalls 1013 extending around a periphery of the base 1011. The base 1011 and the four sidewalls 1013 cooperatively define a chamber 107. Each LED 105 includes a base portion 1053 and a light-emitting portion 1051 disposed on the base portion 1053. The LEDs 105 are electrically connected to a printed circuit board 107, and the printed circuit board 107 is fixed to the base 1011 of the housing 101. The light reflective plate 102 is disposed on the LEDs 105 in the chamber 107. The light reflective plate 102 defines a plurality of through holes (not labeled) that allows the light-emitting portions 1051 of the LED 105 to pass through and emit light to be transmitted to the light diffusion plate 103. The light diffusion plate 103 and the prism sheet 104 are stacked in that order on the chamber 107. Light emitted from the LEDs 105 is substantially reflected by the light reflective sheet 102 to enter the light diffusion plate 103, and diffused uniformly in the light diffusion plate 103, and finally surface light is output from the prism sheet 104.

Generally, a plurality of dark areas may occur because of a reduced intensity of light between adjacent LEDs 105. In the backlight module 100, each LED 105 further includes a reflective sheet 106 disposed on the top of the light-emitting portion 1051, configured for decreasing the brightness of a portion of the backlight module 100 above the LED 105. However, the brightness of the backlight module 100 is still unduly non-uniform. In addition, to enhance the uniformity of brightness of the backlight module 100, there must be a certain space between the light diffusion plate 103 and the LEDs 105. This space can eliminate potential dark areas. Therefore the backlight module 100 may be unduly thick, and the overall intensity of the output light is reduced.

What is needed, therefore, is a new optical plate and a backlight module using the optical plate that can overcome the above-mentioned shortcomings.

### SUMMARY

An optical plate according to a preferred embodiment includes at least one transparent plate unit. The transparent plate unit includes a first surface, a second surface, a plurality of microstructures, a plurality of spherical depressions and a lamp-receiving portion. The second surface is opposite to the first surface. The microstructures are formed at the first surface. Each microstructure includes at least three side surfaces connected with each other, a transverse width of each side surface decreasing along a direction away from the first surface. The spherical depressions are formed at the second surface. The lamp-receiving portion is defined in at least one of the first surface and the second surface.

A backlight module according to a preferred embodiment includes a housing, a side-lighting type point light source, an optical plate, and a light diffusion plate. The housing includes a base and a plurality of sidewalls extending around a periphery of the base, the base and the sidewalls cooperatively forming an opening. The point light source is disposed on the base, each point light source having a light-emitting portion. The same optical plate as described in the previous paragraph is employed in this embodiment. The light-emitting portion of the point light source is inserted in the lamp-receiving portion of the optical plate correspondingly. The light diffusion plate is disposed on the housing over the opening.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout several views, and all the views are schematic.

FIG. 1 is a side cross-sectional view of a backlight module using an optical plate according to a first preferred embodiment of the present invention.

FIG. 2 is an isometric view of the optical plate of FIG. 1.

FIG. 3 is a cross-sectional view taken along line III-III of FIG. 2.

FIG. 4 is an isometric, inverted view of the optical plate of FIG. 2.

FIG. 5 is a side cross-sectional view of an optical plate according to a second preferred embodiment of the present invention.

FIG. 6 is a side cross-sectional view of an optical plate according to a third preferred embodiment of the present invention.

FIG. 7 is an exploded, isometric view of an optical plate according to a fourth preferred embodiment of the present invention.

FIG. 8 is a bottom plan view of an optical plate according to a fifth preferred embodiment of the present invention.

FIG. 9 is a side cross-sectional view of a conventional backlight module.

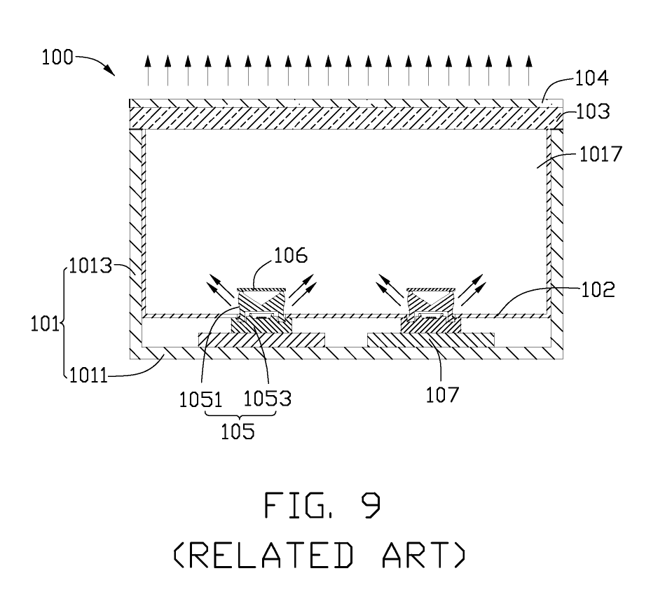

### DETAILED DESCRIPTION OF THE PREFERRED EMBODIMENTS

Reference will now be made to the drawings to describe preferred embodiments of the present optical plate and backlight module, in detail.

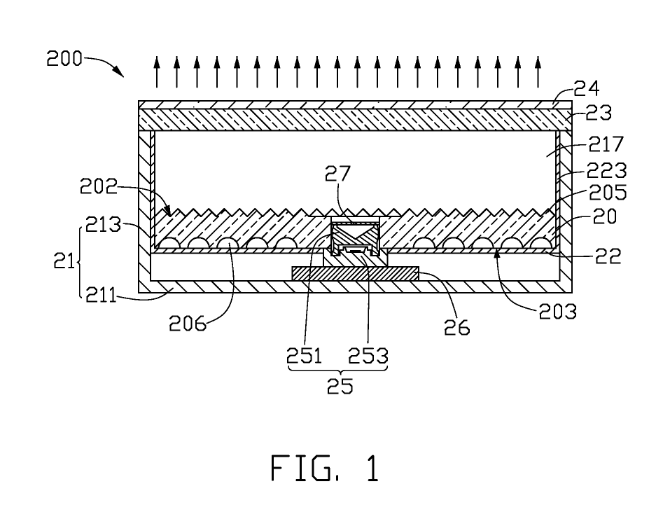

Referring to FIG. 1, a backlight module 200 in accordance with a first preferred embodiment is shown. The backlight module 200 includes a housing 21, an optical plate 20, a light reflective plate 22, a light diffusion plate 23, a LED 25, and a reflective member 27. The housing 21 includes a rectangular base 211 and four sidewalls 213 extending around a periphery of the base 211 correspondingly. The base 211 and the sidewalls 213 cooperatively form an opening 217. The light diffusion plate 23 is disposed on the housing 21 over the opening 217. The optical plate 20, the light reflective plate 22 and the LED 25 are received in the housing 21.

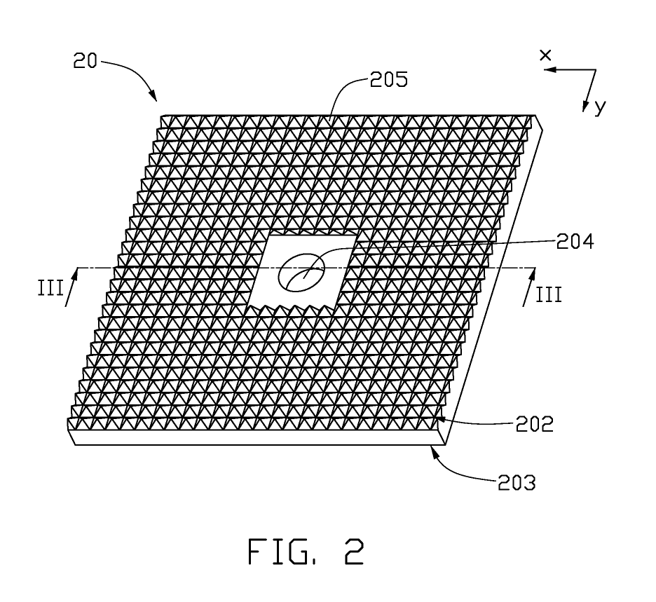

Referring to FIGS. 2 through 4, the optical plate 20 is a transparent square plate, and can be mounted into the housing 21. The optical plate 20 includes a light output surface 202, a bottom surface 203 opposite to the light output surface 202. A plurality of microstructures 205 are formed on the light output surface 202. A plurality of spherical depressions 206 are formed in the bottom surface 203. The optical plate 20 further includes a lamp-receiving portion 204 defined at a center of the bottom surface 203. In this embodiment, the lamp-receiving portion 204 is a through hole that communicates between the light output surface 202 and the bottom surface 203. The optical plate 20 can be made from material selected from the group consisting of polycarbonate (PC), polymethyl methacrylate (PMMA), polystyrene (PS), copolymer of methylmethacrylate and styrene (MS), and any suitable combination thereof.

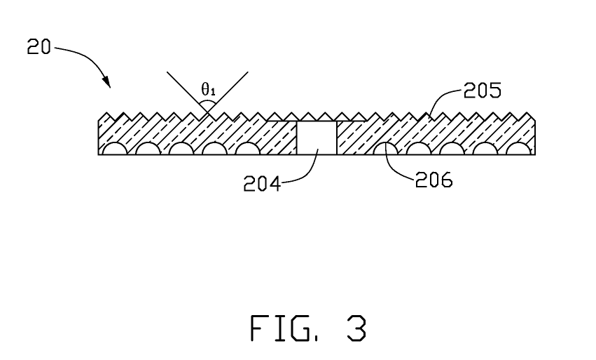

Referring to FIG. 2, the microstructures 205 are distributed in a matrix manner. The rows and columns of the microstructures 205 in the matrix are parallel to the edges of the optical plate 20 (along the X-axis and Y-axis directions). Each microstructure 205 includes four side surfaces (not labeled) connected with each other, a transverse width of each side surface decreasing along a direction away from the light output surface 202. A pitch between adjacent microstructures 205 along the X-axis direction or the Y-axis direction is configured to be in a range from about 0.025 millimeters to about 2 millimeters. Also referring to FIG. 3, a dihedral angle θ₁ defined by side surfaces at opposite sides of each of the microstructures 205 is configured to be in a range from about 60 degrees to about 120 degrees.

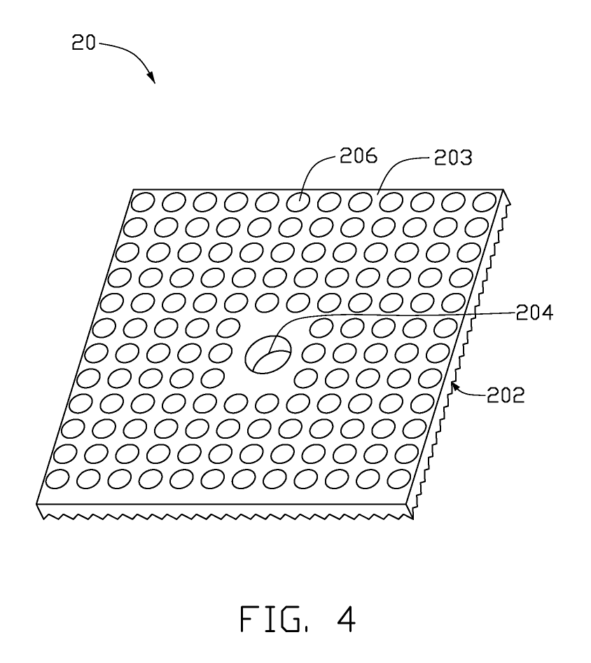

Referring to FIG. 4, in this embodiment, each spherical depression 206 are formed in the bottom surface 203 in a matrix manner. In this embodiment, each of the spherical depressions 206 is identical. A pitch between adjacent spherical depressions 206 is configured to be in a range from about 0.025 millimeters to about 2 millimeters. Either a depth or a radius of each spherical depression 206 is preferably in a range from about 0.01 millimeters to about 2 millimeters.

Again referring to FIG. 1, in this embodiment, the LED 25 includes a base portion 253, and a light-emitting portion 251 disposed on the base portion 253. The LED 25 is electrically connected to a printed circuit board 26 that is fixed to the base 211 of the housing 21. In this embodiment, the reflective member 27 is a light reflective sheet positioned on the top of the light-emitting portion 251. The optical plate 20 is positioned in the housing 21 such that the lamp-receiving portion 204 of the optical plate 20 receives the light-emitting portion 251 of the LED 25 with the reflective member 27. The light output surface 202 of the optical plate 20 faces the opening 217. The light reflective plate 22 defines a through hole (not labeled). The light reflective plate 22 is disposed under the bottom surface 203 of the optical plate 20, the LED 25 passing through the light reflective plate 22 via the through hole.

In use, light emitted from the light-emitting portion 251 of the LED 25 enters the optical plate 20 via an inner surface of the lamp-receiving portion 204. A significant amount of light transmits to the optical plate 20. An amount of light is reflected at the spherical depressions 206 and/or the light reflective plate 22, and finally is outputted from the light output surface 202. Accordingly, a light energy utilization rate of the backlight module 200 is increased.

In addition, the microstructures 205 can condense and collimate emitted light, thereby improving a light illumination brightness. Furthermore, because the side-lighting type LED 25 is positioned in the lamp-receiving portion 204, light is uniformly outputted from the light output surface 202 of the optical plate 20 except that the portion above the LED 25 has a relatively low light output illumination. Light from the optical plate 20 can be further substantially mixed in a chamber between the optical plate 20 and the light diffusion plate 23, and finally uniform surface light is outputted from the light diffusion plate 23. A distance from the LED 25 to the light diffusion plate 23 may be configured to be very small, with little or no potential risk of having dark areas on the portion of the backlight module 200 directly above the LED 25. Accordingly, the backlight module 200 can have a compact configuration while still providing good, uniform optical performance.

It should be pointed out that, the light reflective plate 22 can be omitted. In an alternative embodiment, a high reflectivity film can be deposited on inner surfaces of the base 211 and the sidewalls 213 of the housing 21. In other alternative embodiment, the housing 21 is made of metal materials, and has high reflectivity inner surfaces.

It is to be understood that, in order to improve brightness of the backlight module 200 within a specific viewing range, the backlight module 200 can further include a prism sheet 24 disposed on the light diffusion plate 23. In addition, in order to improve light energy utilization rate of the backlight module 200, the light reflective plate 22 can further include four reflective sidewalls 223 extending around a periphery thereof and in contact with the corresponding sidewalls 213 of the housing 21. Furthermore, the rows or columns of the microstructures 205 may not be parallel to the respective edges of the optical plate 20 but have other alignments or orientations.

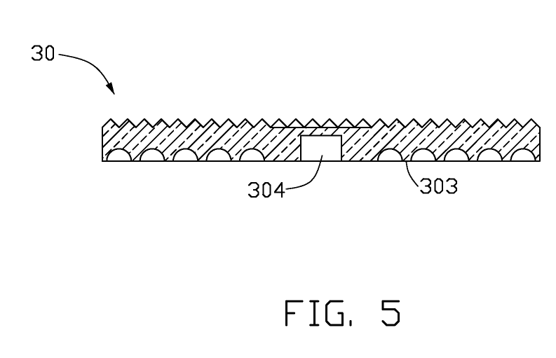

Referring to FIG. 5, an optical plate 30 in accordance with a second preferred embodiment is shown. The optical plate 30 is similar in principle to the optical plate 20 of the first embodiment, however the lamp-receiving portion 304 of the optical plate 30 is a blind hole. It should be pointed out that, a reflective member (not shown) can be a reflective film formed on the top of the light-emitting portion of an LED (not shown). The LED with the reflective member can be mounted into the lamp-receiving portion 304 of the optical plate 30 to form a backlight module. Alternatively, a reflective member can be a reflective sheet positioned on a part of the optical plate 30 above the lamp-receiving portion 304.

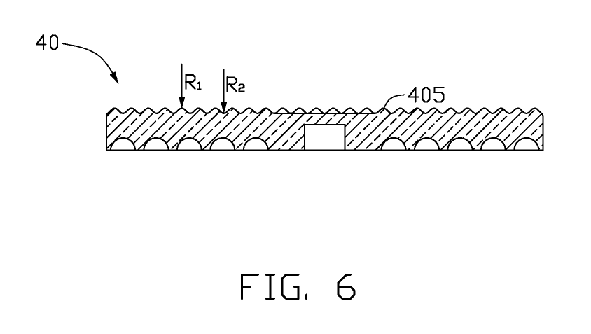

Referring to FIG. 6, an optical plate 40 in accordance with a third preferred embodiment is shown. The optical plate 40 is similar in principle to the optical plate 20 of the first embodiment, except that either dihedral angles defined by two opposite side surfaces of each microstructure 405 of the optical plate 40 or base angles defined by adjacent microstructures 405 of the optical plate 40 are rounded. The curvature of the rounded surface is defined by a sphere of radius R. The radius R₁ of the rounded top edge and the radius R₂ of the rounded bottom edge is equal to or less than 1.1 millimeters, and greater than zero. It is to be understood that, one or more of the dihedral angles defined by two opposite side surfaces of each microstructure, the bottom angles defined by two adjacent microstructures can also be rounded.

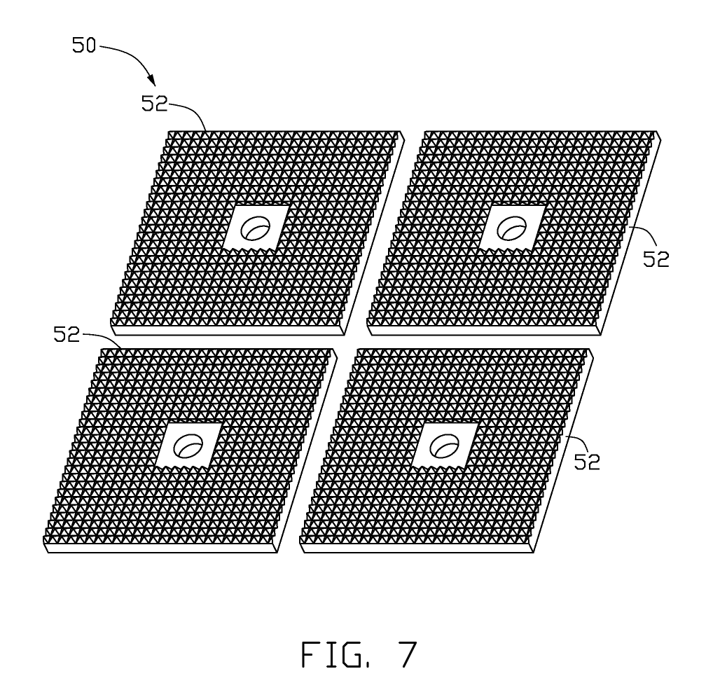

Referring to FIG. 7, a combined optical plate 50 in accordance with a fourth preferred embodiment is shown. The optical plate 50 includes four transparent plate units 52. Each transparent plate unit 52 is the same as the optical plate 20 of the first embodiment. The four transparent plate units 52 are tightly combined with each other to form the combined optical plate 50. It is to be understood that four side-lighting type LEDs and the combined optical plate 50 can be mounted into a housing to form a larger size backlight module.

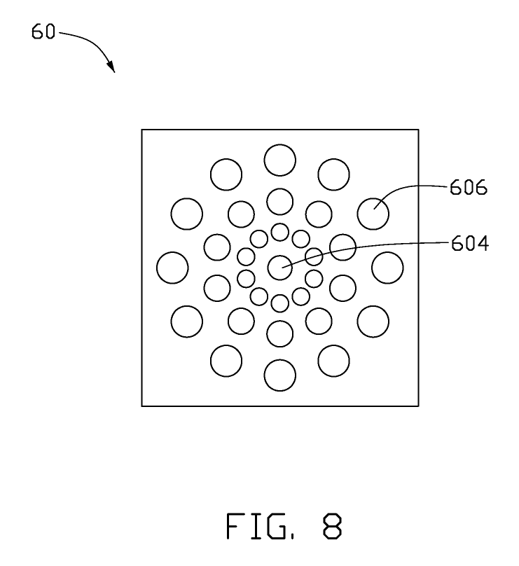

Referring to FIG. 8, another combined optical plate 60 in accordance with a fifth preferred embodiment is shown. The optical plate 60 is similar in principle to the optical plate 20, however sizes of spherical depressions 606 are changed. Sizes of the spherical depressions 606 increases along a direction away from the lamp-receiving portion 604.

It is noted that the scope of the present optical plate is not limited to the above-described embodiments. In particular, even though specific shape of microstructures (pyramidal protrusions) 205, 405 have been described and illustrated, the microstructures (pyramidal protrusions) 205, 405 can have various other suitable shapes. For example, the microstructures can be three-sided (triangular) pyramidal protrusions, five-sided (pentagonal) pyramidal protrusions, multi-sided (polygonal) pyramidal protrusions, or frustums of these.

It should be noted that, in the backlight module 200, not only can the optical plate 20 be positioned in the housing 21 with the light output surface 202 faces the light diffusion plate 23, but can also the optical plate 20 be positioned in the housing 21 with the bottom surface 203 faces the light diffusion plate 23. That is, the microstructures 205 are formed at a first surface of the optical plate 20, and the spherical depressions 206 are formed at a second surface of the optical plate 20. The first surface is selected from one of the light output surface 202 and the bottom surface 203, and the second surface is selected from the other one of the light output surface 202 and the bottom surface 203.

In a backlight module using the combined optical plate of the fourth embodiment, a plurality of red, green, and blue colored LEDs can be inserted into the lamp-receiving portions of the combined optical plates, such that a mixed white surface light can be obtained. It is to be understood that other kinds of point light source, such as field emission lamps and so on, can replace the LEDs 25 in above embodiments.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. An optical plate comprising:
at least one transparent plate unit having:
a first surface;
a second surface opposite to the first surface;
a plurality of microstructures formed at the first surface, wherein each microstructure comprises at least three side surfaces connected with each other, a transverse width of each side surface decreasing along a direction away from the first surface;
a plurality of spherical depressions formed at the second surface; and
at least a lamp-receiving portion defined in at least one of the first surface and the second surface.

2. The optical plate according to claim 1, wherein the microstructures are selected from a group consisting of triangular pyramidal protrusions, rectangular pyramidal protrusions, pentagonal pyramidal protrusions, polygonal pyramidal protrusions, and frustums of these.

3. The optical plate according to claim 2, wherein the microstructures are rectangular pyramidal protrusions, a dihedral angle defined by two opposite side surfaces of each of the microstructures is configured to be in a range from about 60 degrees to about 120 degrees.

4. The optical plate according to claim 2, wherein the microstructures are rectangular pyramidal protrusions, a pitch of the two adjacent microstructures is configured to be in a range from about 0.025 millimeters to about 2 millimeters.

5. The optical plate according to claim 2, wherein the microstructures are rectangular pyramidal protrusions, one or more of dihedral angles defined by two opposite side surfaces of each microstructure and base angles defined by two adjacent microstructures, are rounded.

6. The optical plate according to claim 1, wherein the microstructures are distributed on the first surface in a matrix manner, and one array of the matrix of the microstructures are distributed along a direction parallel to or slanted to edges of the optical plate.

7. The optical plate according to claim 1, wherein each spherical depression is distributed on the second surface in a matrix manner.

8. The optical plate according to claim 7, wherein a pitch of two adjacent spherical depressions is in a range from about 0.025 millimeters to about 2 millimeters; either a depth or a radius of each spherical depression is in a range from about 0.01 millimeters to about 2 millimeters.

9. The optical plate according to claim 1, wherein sizes of the spherical depressions increases along a direction away from the lamp-receiving portion.

10. The optical plate according to claim 1, wherein the lamp-receiving portion is selected from one of blind hole and through hole communicating between the first surface and the second surface.

11. The optical plate according to claim 1, wherein the optical plate includes a plurality of the transparent plate units, the transparent plate units being tightly combined with each other.

12. A backlight module comprising:
a housing having a base and a plurality of sidewalls extending from a periphery of the base, the base and the sidewalls cooperatively forming an opening;
at least one point light source disposed on the base, each point light source having a light-emitting portion;
at least one reflective member disposed on the top of the light-emitting portion of the at least one point light source;
an optical plate positioned in the housing, the optical plate including at least one transparent plate unit having:
a first surface;
a second surface opposite to the first surface;
a plurality of microstructures formed at the first surface, wherein each microstructure comprises at least three side surfaces connected with each other, a transverse width of each side surface decreasing along a direction away from the first surface;
a plurality of spherical depressions formed at the second surface; and
a lamp-receiving portion defined in at least one of the first surface and the second surface, wherein the light-emitting portion of the at least one point light source is inserted in the lamp received portion; and
a light diffusion plate disposed on the housing over the opening.

13. The backlight module according to claim 12, further comprising a light reflective plate defining a through hole therein, the light reflective plate being disposed underneath the bottom surface of the optical plate, and the point light source passing through the light reflective plate via the through hole.

14. The backlight module according to claim 13, wherein the light reflective plate further comprises a plurality of reflective sidewalls extending from a periphery thereof and contact with the sidewalls of the housing.

15. The backlight module according to claim 12, wherein the housing is made of metal materials, and has high reflectivity inner surfaces.

16. The backlight module according to claim 12, further comprising a high reflectivity film deposited on inner surfaces of the base and the sidewalls of the housing.

17. The backlight module according to claim 12, further comprising a prism sheet disposed on the light diffusion plate.

18. The backlight module according to claim 12, wherein the microstructures are selected from a group consisting of triangular pyramidal protrusions, rectangular pyramidal protrusions, pentagonal pyramidal protrusions, polygonal pyramidal protrusions, and frustums of these.

19. The backlight module according to claim 12, wherein the lamp-receiving portion is selected from one of blind hole and through hole communicating between the first surface and the second surface.
